(19) United States
(12) Patent Application Publication
(10) Pub. No.: US 2019/0266310 A1
(43) Pub. Date: Aug. 29, 2019

(54) RULE CHECK STRUCTURES

(71) Applicant: GLOBALFOUNDRIES INC., Grand Cayman (KY)

(72) Inventors: Uwe P. SCHROEDER, Santa Cruz, CA (US); Mohamed A.A. ISMAIL, Livermore, CA (US); Nikhil BUDDI, Ballston Lake, NY (US)

(21) Appl. No.: 15/904,895

(22) Filed: Feb. 26, 2018

(51) Int. Cl. G06F 17/50

(52) U.S. Cl. CPC G06F 17/5081

(57) ABSTRACT

The present disclosure generally relates to semiconductor structures and, more particularly, to rule check structures and methods of manufacture. The method includes matching, by a computing device, patterns in a design layer to approved patterns; determining, by the computing device, a similarity between at least one unmatched pattern and the approved patterns; and correcting, by the computing device, the at least one unmatched pattern to match a pattern with the closest similarity out of the approved patterns.

### FIELD OF THE INVENTION

The present disclosure generally relates to semiconductor structures and, more particularly, to rule check structures and methods of manufacture.

### BACKGROUND

In the fabrication of semiconductor structures, patterns are created and followed in the arrangement of features and their respective connections in the build structure. As semiconductor processes continue to scale downwards, e.g., shrink, the desired spacing between the features (i.e., the pitch) also becomes smaller. In this way, any variation from the approved designs can cause issues in the build structure.

In order to verify the accuracy of the patterns, the patterns can be checked against existing approved designs. In rule-in check analysis, any pattern in the test layout which does not match a pre-approved rule-in pattern is considered a violation and is flagged. In the rule-out check analysis, any pattern in the test layout which matches the rule-out pattern is considered a violation and is flagged. In this way, rule-out checks are designs which are checked against certain dimensional criteria, while rule-in checks pick from a list of allowed configurations. For rule-in checks, everything not in the list is an illegal design and will be flagged as a violation. More specifically, rule-in checks look for a predefined set of structures, i.e., patterns or line/space combinations, that are allowed, and any structure that is not part of the pre-defined set of structures will be flagged as an error. However, these flagged patterns need resolution.

Rule-in check violations are relatively hard to fix and debug, especially if there are many allowed configurations. Further, once an error is detected, it is difficult, if not impossible, to determine which one of the pre-defined structures in the pre-approved rule-in patterns was the intended design. For example, if there are hundreds of allowed structures, i.e., pre-approved rule-in patterns, to select from, it can be difficult and time consuming to fix the failed pattern in view of the hundreds of allowed structures. In this way, the designer has no visibility on how many fixes have to be done.

### SUMMARY

In an aspect of the disclosure, a method comprises: matching, by a computing device, patterns in a design layer to approved patterns; determining, by the computing device, a similarity between at least one unmatched pattern and the approved patterns; and correcting, by the computing device, the at least one unmatched pattern to match a pattern with the closest similarity out of the approved patterns.

In an aspect of the disclosure, a computer program product comprises: a computer readable storage medium having program instructions embodied therewith, and the program instructions are readable by a computing device to cause the computing device to: find a match between patterns in a layout and patterns from a design library; flag patterns which do not match the patterns from the design library; calculate similarity scores between the flagged patterns and the patterns from the design library; and correct the flagged patterns to match the patterns from the design library which have the closest similarity scores.

In an aspect of the disclosure, a system for rule checking comprises: a CPU, a computer readable memory and a computer readable storage media; first program instructions to match patterns in a layer to approved patterns; second program instructions to determine a similarity between at least one unmatched pattern and the approved patterns; and third program instructions to correct the at least one unmatched pattern to match a pattern with the closest similarity out of the approved patterns, wherein the first, second and third program instructions are stored on the computer readable storage media for execution by the CPU via the computer readable memory.

### BRIEF DESCRIPTION OF THE DRAWINGS

The present disclosure is described in the detailed description which follows, in reference to the noted plurality of drawings by way of non-limiting examples of exemplary embodiments of the present disclosure.

FIG. 1 shows a design layer, amongst other features, in accordance with aspects of the present disclosure.

FIGS. 2A-2C show a rule-in check analysis, amongst other features, in accordance with aspects of the present disclosure.

FIG. 3 shows a flow diagram for a rule-in check analysis, amongst other features, in accordance with aspects of the present disclosure.

FIG. 4 shows a similarity process which compares and corrects patterns, amongst other features, in accordance with aspects of the present disclosure.

FIGS. 5A-5D show various pattern similarity examples, amongst other features, accordance with aspects of the present disclosure.

FIGS. 6A-6C shows the topography of a thickness variation, amongst other features, and respective fabrication processes in accordance with aspects of the present disclosure.

FIG. 7 shows an illustrative infrastructure for implementing pattern analysis and correction in accordance with aspects of the invention.

### DETAILED DESCRIPTION

The present disclosure generally relates to semiconductor structures and, more particularly, to rule check structures and methods of manufacture. In embodiments, the processes described herein include a pattern analysis to ensure that the patterns implemented in the build structure are allowed. For example, a pattern analysis can comprise rule-in checks, in which pre-approved rule-in patterns are compared against patterns in a test layout. As another example, pattern analysis can comprise rule-out checks, in which pre-approved rule-out patterns are compared against patterns in a test layout. Advantageously, the structures and processes described herein provide designers with a way to handle rule-in check violations, thereby reducing design debug time significantly.

The structures and processes described herein address the problems of fixing and debugging rule-in check violations by determining a similarity index between an existing failed pattern and predefined allowed structures, i.e., the pre-approved rule-in patterns. The pre-approved rule-in pattern with the closest similarity index to the failed pattern is displayed as a fixing hint. The failed pattern is then corrected to match this pre-approved rule-in pattern with the closest similarity index. More specifically, the structures and processes described herein determine a similarity score of existing fails to predefined allowed patterns, pick the most similar allowed pattern, and group the rule-in violations into respective sub categories to allow for better fixing and disposition. In further embodiments, in addition to pattern analysis, the structures and processes described herein can determine the existence of a failed pattern by size measurements.

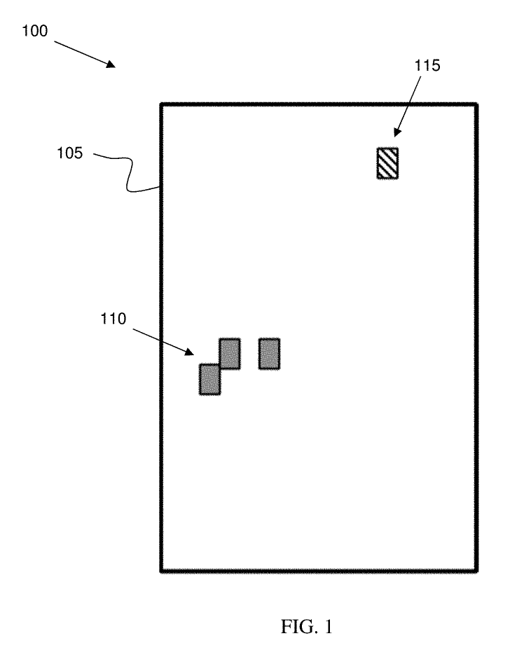

FIG. 1 illustrates a structure 100 comprising a design layer 105 in accordance with aspects of the present disclosure. In embodiments, the design layer 105 consists of various markers 110, 115, which signify locations of patterns, e.g., x, y coordinates. These patterns of the markers 110, 115 can represent different standard cell track configurations, amongst other examples. In embodiments, the design layer 105 can be any layer, such as a metal layer or any other suitable design layer, including but not limited to a via layer, a Front End of Line (FEOL) layer or a Back End of Line (BEOL) layer, amongst other examples.

In embodiments, the marker 110 represents patterns which are allowed. Specifically, the patterns of the marker 110 have undergone a rule-in check analysis by being compared to pre-approved rule-in patterns, and have been determined to match the pre-approved rule-in patterns. Therefore, no pattern violations are present at marker 110. In comparison, marker 115 represents at least one pattern violation for the design layer configurations in that specific location of the design layer 105. More specifically, the patterns of the marker 115 have undergone a rule-in check analysis by being compared to pre-approved rule-in patterns, and at least one pattern of the marker 115 has been determined to not match any of the pre-approved rule-in patterns, i.e., a failed pattern. The locations and size of the marker 115 will be flagged and saved within a database array of locations.

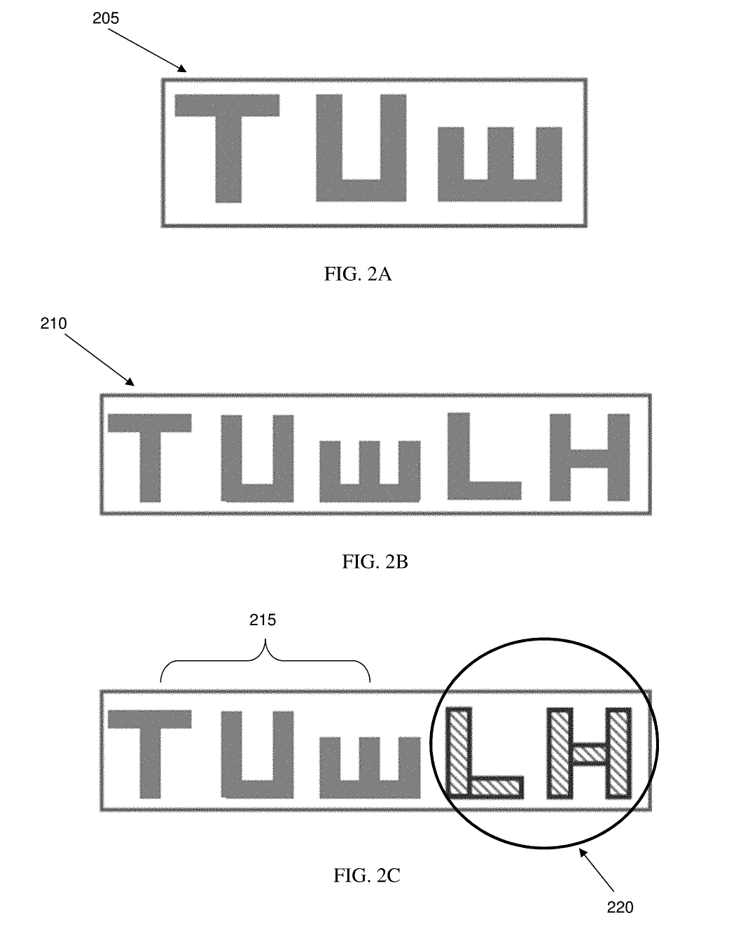

FIGS. 2A-2C represent a rule-in check analysis in accordance with aspects of the present invention. FIG. 2A illustrates a set of pre-approved rule-in patterns 205 to be used in the rule-in check analysis. The pre-approved rule-in patterns 205 are previously determined, allowed configurations from a design library database. The pre-approved rule-in patterns 205 can be any number of patterns, lines, shapes, or sizes, for example.

FIG. 2B shows test layout patterns 210, which represent patterns to be implemented in the design layer 105 of FIG. 1. The test layout patterns 210 can be any number of patterns, lines, shapes, or sizes, for example.

As shown respectively in FIG. 2C, a rule-in check analysis compares the pre-approved rule-in patterns 205 to the test layout patterns 210 in order to determine if any failed patterns are present. Specifically, finding a match between patterns in a layout, i.e., the test layout patterns 210, and patterns from a design library, i.e., the pre-approved rule-in patterns 205. FIG. 2C shows the result of this comparison, with the allowed patterns 215 and the failed patterns 220 out of the test layout patterns 210. In embodiments, the allowed patterns 215 match the pre-approved rule-in patterns 205, while the failed patterns 220 do not match any of the pre-approved rule-in patterns 205. In this way, matched patterns are allowed patterns. More specifically, there is a matching of patterns, i.e., test layout patterns 210, in a design layer 105 to approved patterns, i.e., the pre-approved rule-in patterns 205. Due to this failure of not being matched, the failed patterns 220 will be flagged as violations. In this way, there is a flagging of the at least one unmatched pattern, i.e., the failed pattern 220. Specifically, there is a flagging of patterns which do not match the patterns from the design library.

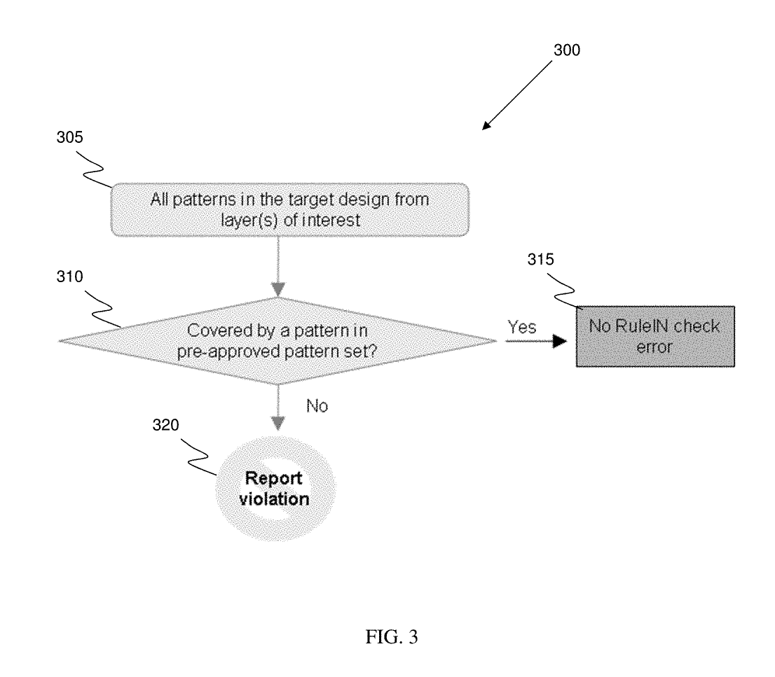

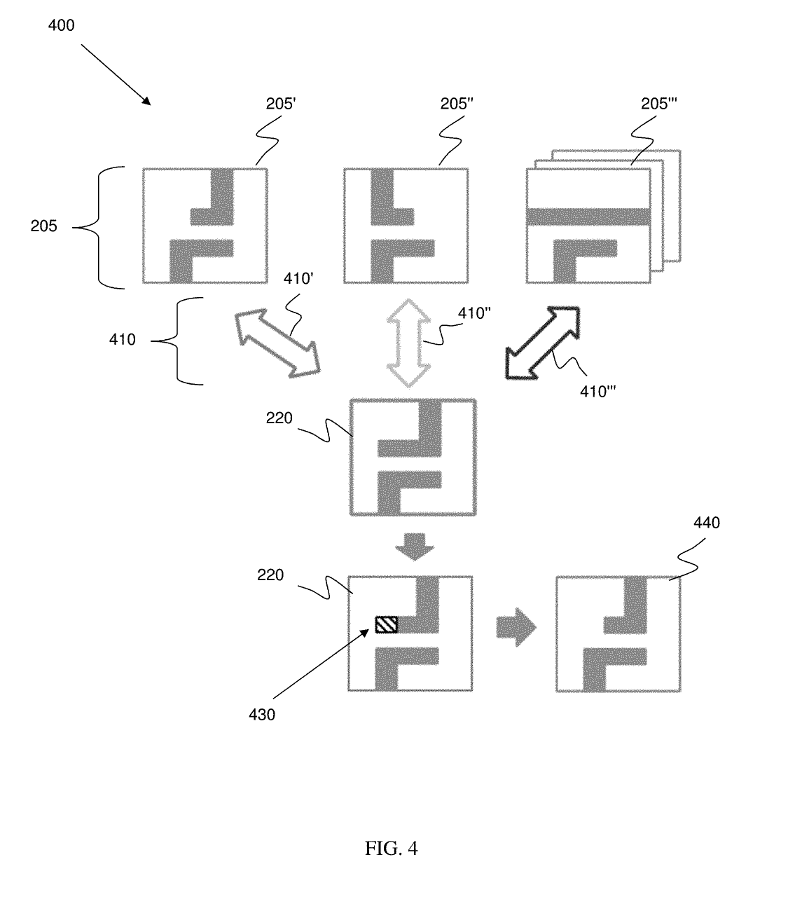

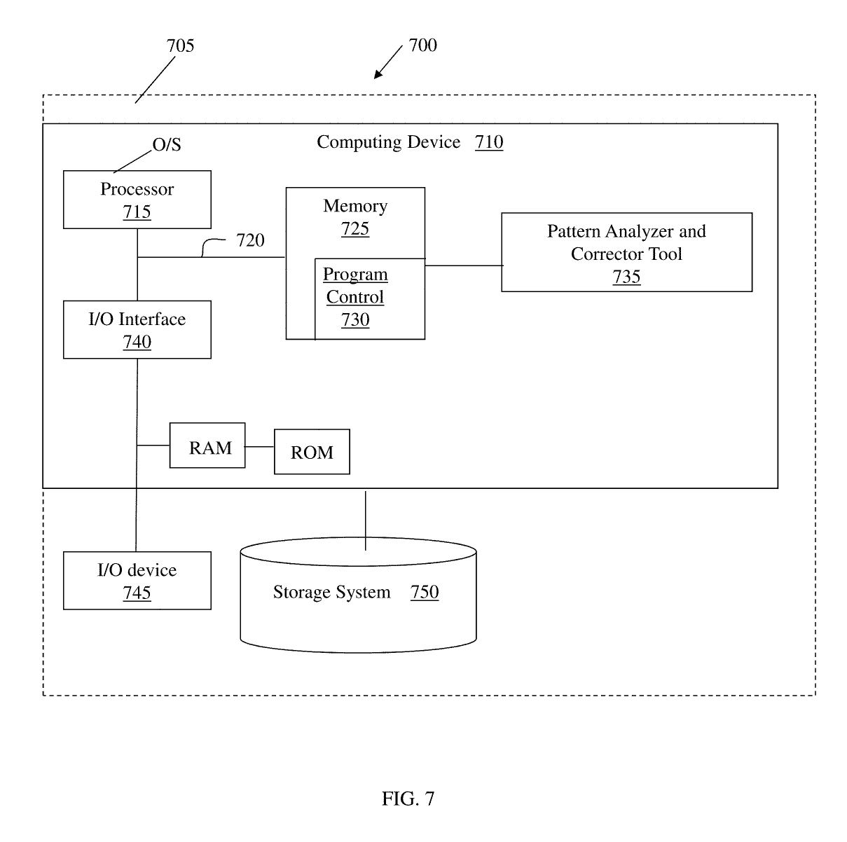

FIG. 3 illustrates a process for a rule-in check analysis in accordance with aspects of the present invention. The process of FIG. 3 can be implemented in the infrastructure shown in FIG. 7. The rule-in check analysis 300 begins with step 305, in which all of the patterns of interest in the target design from the layers of interest, i.e., the test layout patterns 210, are located. Step 310 compares the patterns of interest to patterns of a pre-approved pattern set, i.e., the pre-approved rule-in patterns 205 are compared to the test layout patterns 210. Step 315 illustrates that if all of the patterns of interest are covered by at least one pattern in the pre-approved pattern set, there is no rule-in check error, i.e., allowed patterns 215. Alternatively, step 320 illustrates that if at least one pattern of the patterns of interest is not covered by a pattern of the pre-approved pattern set, a failed pattern 220 exists, and the violation is reported. In this way, the rule-in check analysis 300 looks for a predefined set of structures, e.g., patterns or line/space combinations, that are allowed. Any structure that is not part of the pre-defined set of structures will be flagged as an error and the violation will be reported.

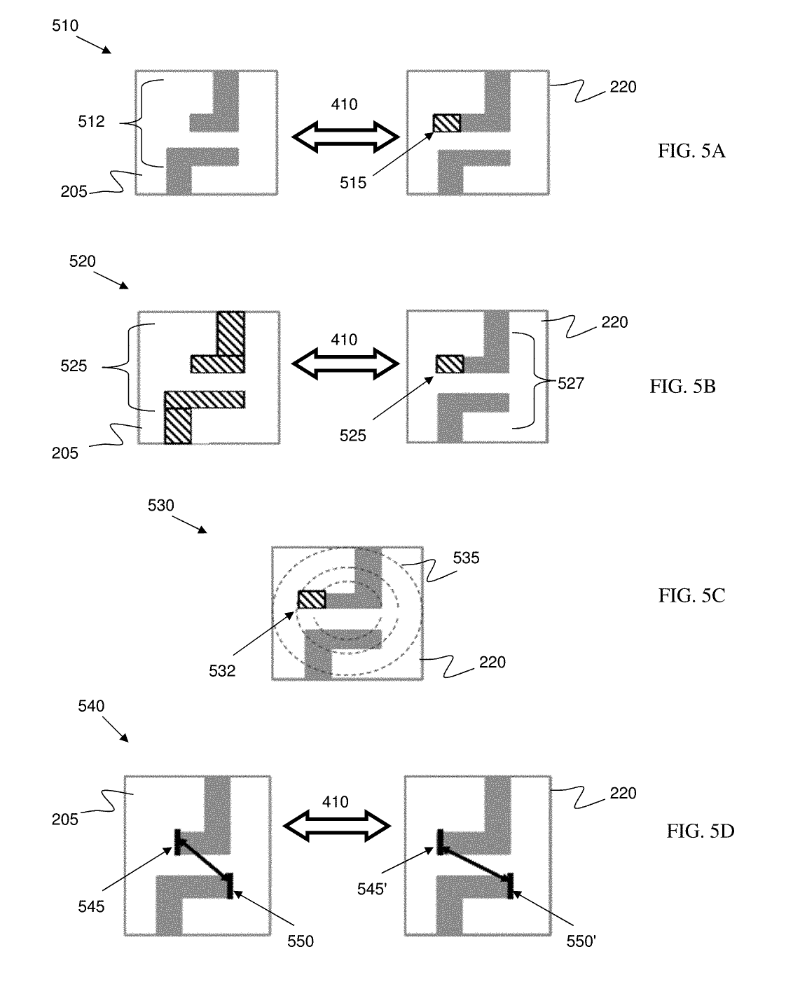

FIGS. 4 and 5A-5D illustrate a similarity process 400 in accordance with aspects of the present invention. As shown in FIG. 4, the similarity process 400 begins with the pre-approved rule-in patterns 205, and specifically the pre-approved structures 205′, 205″, 205′″. The pre-approved structures 205′, 205″, 205′″ are compared to the failed pattern 220 in order to determine a similarity index 410. In this way, there is a calculation of similarity scores between the flagged patterns, i.e., failed patterns 220, and the patterns from the design library, i.e., the pre-approved rule-in patterns 205. More specifically, a similarity index 410 is calculated between each of the pre-approved structures 205′, 205″, 205′″ and the failed pattern 220. For example, a similarity index 410′ is calculated by comparing the features of the pre-approved structure 205′ and the failed pattern 220, a similarity index 410″ is calculated by comparing the features of the pre-approved structure 205″ and the failed pattern 220, and a similarity index 410′″ is calculated by comparing the features of the pre-approved structure 205′″ and the failed pattern 220. In this way, there is a determination of a similarity between at least one unmatched pattern, i.e., the failed pattern 220, and the approved patterns, i.e., the pre-approved structures 205′, 205″, 205′″.

Based on the similarity indexes 410′, 410″, 410′″, a determination can be made for which of the pre-approved structures 205′, 205″, 205′″ of the pre-approved rule-in patterns 205 was the intended design. Previously, it was not possible to determine which one of the pre-defined structures was the intended design. However, by using the similarity indexes 410′, 410″, 410′″, it is now possible to determine what the intended design of the failed pattern 220 was, by picking the most similar allowed pattern.

The most similar allowed pattern of the pre-approved structures 205′, 205″, 205′″, is determined by the similarity index 410 with the highest similarity index score. As an example, the similarity index 410′ can have a score of 98% similarity, while the similarity index 410″ can have a score of 85% similarity and the similarity index 410′″ can have a score of 75% similarity, respectively. In embodiments, a similarity index 410 of 100% indicates identical patterns, while a similarity index 410 of 0% indicates there is no overlap of any structures. Specifically, similarity score of 100% indicates identical patterns between the at least one unmatched pattern and the pattern with the closest similarity, and a similarity score of 0% indicates no overlap between the at least one unmatched pattern and the pattern with the closest similarity. In this way, the similarity index 410′ has the highest similarity index score because it is closest to 100%, indicating that the pre-approved structure 205′ is the most similar pattern compared to the failed pattern 220.

Once the most similar pre-approved structure from the pre-approved rule-in patterns 205 is determined, the failed pattern 220 is further analyzed. Specifically, the failed pattern 220 is analyzed in order to determine the differences between the most similar pre-approved structure and the failed pattern 220. As shown in FIG. 4, the analyzed pattern, i.e., the failed pattern 220, has a non-matching area 430, which is not present in the pre-approved structure 205′. This non-matching area 430 is responsible for the violation and prevents the failed pattern 220 from passing the rule-in check analysis.

Corrected pattern 440 shows the removal of the non-matching area 430 to match the most similar pre-approved structure, i.e., the pre-approved structure 205′. In this way, there is a correction of at least one unmatched pattern, i.e., the failed pattern 220, and the approved patterns, i.e., the pre-approved structure 205′. More specifically, there is a correction of the flagged patterns, i.e., the failed patterns 220, to match the patterns from the design library, i.e., e pre-approved rule-in patterns 205, which have the closest similarity scores. The removal of the non-matching area 430 can be performed by an automated process as described herein. For example, the automated process for fixing the failed pattern 220 includes generating fixing hints to morph the violating pattern to the closest resembling allowed pattern. In this way, the corrected pattern 440 can pass any subsequent rule-in check analysis because the corrected pattern 440 matches the intended design.

In embodiments, the violations, i.e., the failed patterns 220, can be grouped together into respective subcategories. For example, any failed patterns 220 which have the same non-matching area 430 can be grouped together in one subcategory, while other failed patterns 220 with similar non-matching areas 430 can be grouped together into other subcategories. In this way, grouping similar violations together into subcategories allows for better fixing and disposition of the failed patterns 220, because failed patterns 220 which require the same correction allows for a quicker process, as opposed to various different corrections needed for each failed pattern 220 in a set of unrelated failed patterns. In embodiments, the failed pattern violations are grouped into subclasses/subcategories that can be highlighted on a chip map, for example, or can be sorted by cell type.

Accordingly, by implementing the structures and processes herein, it is possible to identify the intended design and correct an identified failed pattern to match the intended design by comparing each marker location, i.e., markers 110, 115, with a pre-existing set of allowed patterns, i.e., pre-approved rule-in patterns 205. By using this comparison, a determination can be made to determine which allowed pattern has the closest similarity to the captured failed pattern 220 at the location of marker 115, by calculating a similarity score, i.e., the similarity index 410. The correction of the failed pattern 220 includes providing fixing guidance to morph the failed pattern 220 to the closest resembling allowed pattern, e.g., pre-approved structures 205′, 205″, 205′″. The correction of the failed pattern 220 can be fully automated, for example.

FIGS. 5A-5D show how various examples of how a similarity index 410 can be determined. More specifically, FIGS. 5A-5D show that determining a similarity comprises calculating a similarity score. FIG. 5A shows a similarity index 410 being calculated between the pre-approved rule-in pattern 205 and the failed pattern 220 using a simple XOR function 510. In this way, a similarity score is calculated by an XOR function. For example, in this process an XOR_area 515 represents the structural difference between the pre-approved rule-in pattern 205 and the failed pattern 220. Additionally, the pattern_extent_area 512 represents the entire structure area of the pre-approved rule-in pattern 205. To determine the similarity index 410 using the simple XOR function 510, the XOR_area 515 is divided by the pattern_extent area 512, with the remainder subtracted from the numeral 1. The simple XOR function 510 can be represented by equation (1) below by similarity index S. In this way, a similarity score is calculated by an XOR function by determining structural differences between the flagged patterns, i.e., failed patterns 220, and the patterns from the design library, i.e., the pre-approved rule-in patterns 205. As an example, if the XOR_area 515 and the pattern_extent_area 512 were the exact same value, the remainder would be 1, causing S=0. In this way, S=0 indicates 100% similarity, i.e., identical patterns.

S=1−XOR_area/pattern_extent_area (1)

FIG. 5B shows a similarity index 410 being calculated between the pre-approved rule-in pattern 205 and the failed pattern 220 using a Jaccard XOR function 520. In this example, the XOR_area 525 encompasses the entirety of the pre-approved rule-in pattern 205 and the structural difference between the pre-approved rule-in pattern 205 and the failed pattern 220. Additionally, the pattern_area 527 represents the remaining structure area of the failed pattern 220. To determine the similarity index 410 using the Jaccard XOR function 520, the XOR_area 525 is divided by the pattern_area 527, with the remainder subtracted from the numeral 1. In this way, the XOR function is a Jaccard XOR function which determines a structural difference between the at least one unmatched pattern, i.e., the failed pattern 220, and the approved patterns, i.e., the pre-approved rule-in patterns 205. The Jaccard XOR function 520 can be represented by equation (2) below by similarity index S.

S=1−XOR_area/pattern_area (2)

FIG. 5C shows a similarity index 410 being calculated from the failed pattern 220 using a weighted XOR function 530. In this example, the structure of the failed pattern 220 is analyzed using a weighting factor 535. Specifically, pattern differences in the middle of the failed pattern 220 are weighted higher than the differences at the edge of the extent of the failed pattern 220. The non-matching area 532 is weighted less since it is at an edge of the extent of the failed pattern 220, in comparison to a non-matching area 532 which may be located in the middle of the failed pattern 220. In this way, weighted XOR function 530 weighs the differences differently depending on their location in the failed pattern 220. As an example, the XOR function is a weighted XOR function which weighs structural differences between the at least one unmatched pattern, i.e., the failed pattern 220, and the approved patterns, i.e., the pre-approved rule-in patterns 205, higher in a middle of the at least one unmatched pattern than other areas of the at least one unmatched pattern.

FIG. 5D shows a similarity index 410 being calculated between the pre-approved rule-in pattern 205 and the failed pattern 220 using a feature vector 540. In this way, determining the similarity comprises calculating a similarity score by a feature vector. Under the feature vector 540, the similarity index 410 is based on a comparison of feature location and density, e.g., line ends, inner vertices, amongst other examples. As shown in FIG. 5D, the location and density of features 545, 550 of the pre-approved rule-in pattern 205 are compared to the location and density of features 545′, 550′ of the failed pattern 220. Specifically, the similarity score, i.e., the similarity index 410, is calculated by a feature vector 540 which compares a location and density of features in the patterns from the design library, the pre-approved rule-in patterns 205, to a location and density of features in the flagged patterns, i.e., the failed patterns 220. Other examples of calculating similarity indexes include using a weighted feature vector, which combines the features of the feature vector 540 together with a weighting factor, such as weighting factor 535. In this way, the feature vector 540 can be a weighted feature vector. An additional example of calculating a similarity index is by image recognition algorithms, amongst other examples. In this way, determining the similarity comprises calculating a similarity score by image recognition algorithms.

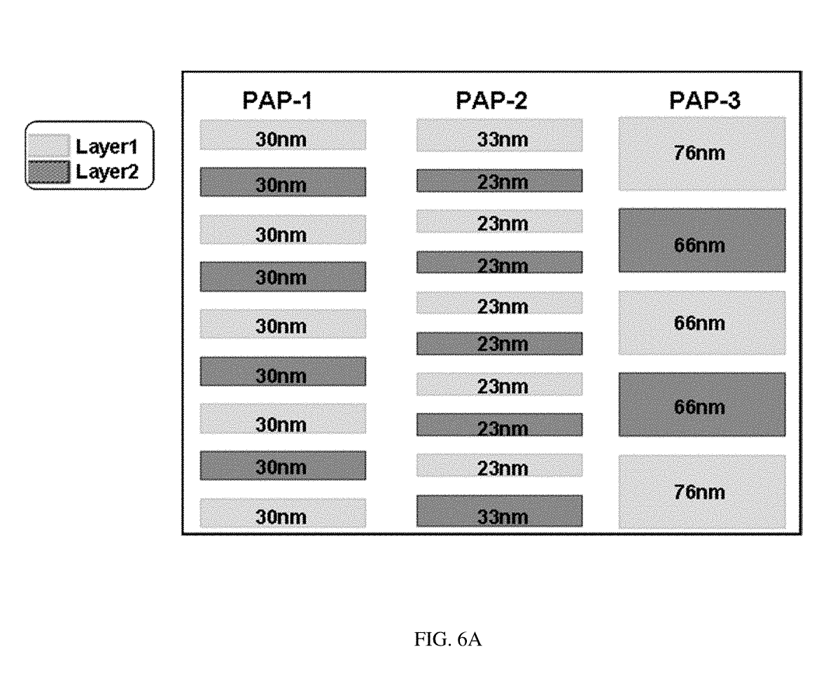

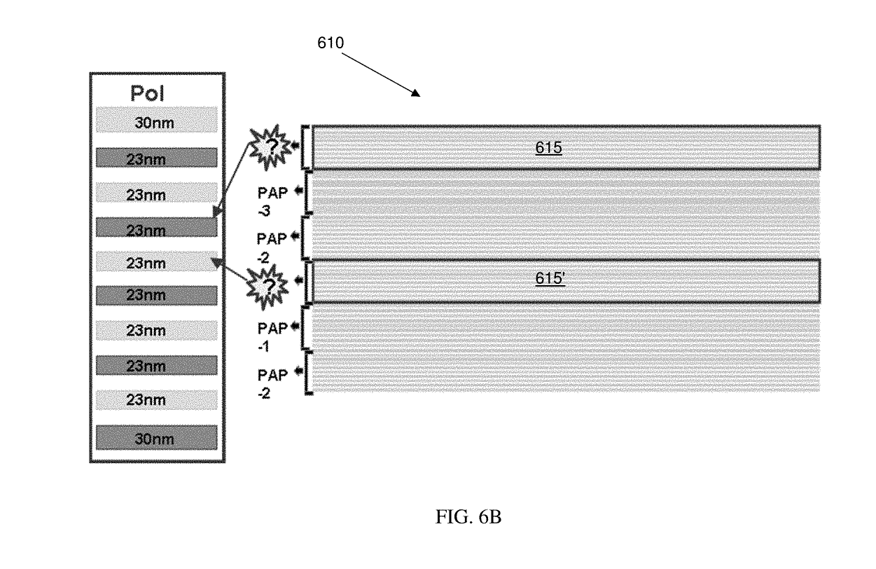

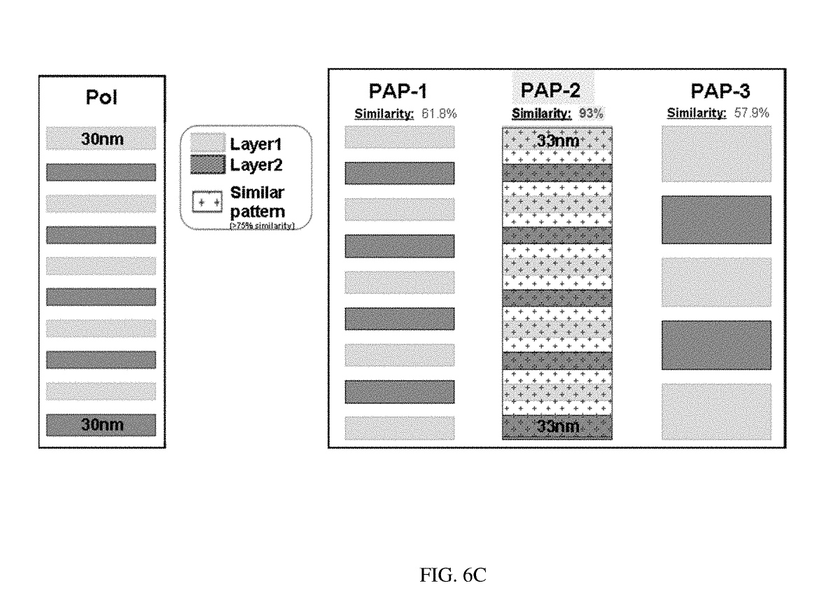

FIGS. 6A-6C illustrate further embodiments for determining the existence of pattern violations. FIG. 6A shows a set of pre-approved patterns (PAP), which are a group of patterns that are allowed to be used in the design. In this embodiment, all layer 1 and layer 2 array of wires which do not belong to one of the PAP patterns, i.e., PAP-1, PAP-2, PAP-3, will be reported as rule-in check violations.

FIG. 6B illustrates a test run on a sample design block 610 for the rule-in checks. The sample design block 610 comprises two instances of unknown arrays of wires 615, 615′. The unknown arrays of wires 615, 615′ of the patterns of interest (POI) are reported as violations since they do not belong to any of the pre-approved set of the PAP patterns PAP-1, PAP-2, PAP-3. Specifically, the unknown arrays of wires 615, 615′ have an array of 23 nm wires, and none of the PAP patterns PAP-1, PAP-2, PAP-3, match the other layers of the POI. For example, the first layer in the POI has an array of 30 nm wires and the second layer has an array of 23 nm wires, but the first layer in the PAP-1 has an array of 30 nm wires and the second layer has an array of 30 nm wires, which is not a match to the POI. As another example, the first layer in the PAP-2 has an array of 33 nm wires and the second layer has an array of 23 nm wires, which is not a match to the POI. As another example, the first layer in the PAP-3 has an array of 76 nm wires and the second layer has an array of 66 nm wires. In this way, none of the PAP patterns PAP-1, PAP-2, PAP-3 match the POI.

FIG. 6C shows a similarity check between the POI and the PAP patterns PAP-1, PAP-2, PAP-3, in order to determine which PAP pattern is most similar to the POI. In embodiments, each marker location within the PAP patterns PAP-1, PAP-2, PAP-3 are analyzed for a similarity index to the POI. As an example, a similarity threshold can be set at 75% to filter out PAP patterns which have a similarity index which fall below the threshold. In this example, the PAP pattern PAP-2 is most similar to the POI because the similarity index score is at 93%, while the other PAP patterns PAP-1, PAP-3 are not considered because their similarity index scores fall below the similarity threshold. In this way, there is a setting of a threshold for a similarity score, i.e., the similarity index. As shown in FIG. 6C, both the POI and PAP-2 have an array of 23 nm wires, but the POI has a termination of 30 nm in place of the pre-approved 33 nm termination found in PAP-2. Similar to the fixing of the failed pattern 220 to create the corrected pattern 440, a fixing guidance can be provided to the user to change the array of 30 nm wires in the POI to an array of 33 nm wires.

As will be appreciated by one of ordinary skill in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects. Furthermore, aspects of the present disclosure may take the form of a computer program product embodied in one or more computer readable storage medium(s) having computer readable program code embodied thereon.

The computer readable storage medium (or media) having computer readable program instructions thereon causes one or more computing processors to carry out aspects of the present disclosure. The computer readable storage medium can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following non-transitory signals: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. The computer readable storage medium is not to be construed as transitory signals per se; instead, the computer readable storage medium is a physical medium or device which stores the data. The computer readable program instructions may also be loaded onto a computer, for execution of the instructions, as shown in FIG. 7.

FIG. 7 shows a computer infrastructure 700 for implementing the steps in accordance with aspects of the disclosure. To this extent, the infrastructure 700 can implement the pattern analysis and correction of the failed patterns 220 of FIGS. 2A-2C, 4 and 5, and also the failed array of wires, i.e., the unknown arrays of wires 615, 615′. The infrastructure 700 includes a server 705 or other computing system that can perform the processes described herein. In particular, the server 705 includes a computing device 710. The computing device 710 can be resident on a network infrastructure or computing device of a third-party service provider (any of which is generally represented in FIG. 7).

The computing device 710 includes a processor 715 (e.g., CPU), memory 725, an I/O interface 740, and a bus 720. The memory 725 can include local memory employed during actual execution of program code, bulk storage, and cache memories which provide temporary storage of at least some program code in order to reduce the number of times code which are retrieved from bulk storage during execution. In addition, the computing device includes random access memory (RAM), a read-only memory (ROM), and an operating system (O/S).

The computing device 710 is in communication with external I/O device/resource 745 and storage system 750. For example, the I/O device 745 can comprise any device that enables an individual to interact with computing device 710 (e.g., user interface) or any device that enables computing device 710 to communicate with one or more other computing devices using any type of communications link. The external I/O device/resource 745 may be for example, a handheld device, PDA, handset, keyboard etc.

In general, processor 715 executes computer program code (e.g., program control 730), which can be stored in memory 725 and/or storage system 750. Moreover, in accordance with aspects of the invention, program control 730 controls a pattern analyzer and corrector tool 735, which rule-in check analysis and subsequent correction of failed patterns. The pattern analyzer and corrector tool 735 can be implemented as one or more program codes in program control 730 stored in memory 725 as separate or combined modules. Additionally, the non-flatness analyzer tool 735 may be implemented as separate dedicated processors or a single or several processors to provide the function of this tool. While executing the computer program code, the processor 715 can read and/or write data to/from memory 725, storage system 750, and/or I/O interface 740. The program code executes the processes of the invention. The bus 720 provides a communications link between each of the components in computing device 710.

The pattern analyzer and corrector tool 735 is utilized to identify the intended design and correct any failed patterns to match the intended design. The pattern analyzer and corrector tool 735 initiates the rule-in check analysis by comparing the test layout patterns 210 at each marker location, i.e., markers 110, 115, with a pre-existing set of allowed patterns, i.e., the pre-approved rule-in patterns. The pre-approved rule-in patterns can be stored in a design library/database which is part of the storage system 750, or as a separate database, for example.

By comparing the pre-approved rule-in patterns with the test layout patterns 210, a determination can be made as to which, if any, patterns in the test layout patterns 210 fail, i.e., do not match the pre-approved rule-in patterns. All failed patterns will be flagged and reported as violations by the pattern analyzer and corrector tool 735. The failed patterns are grouped together by the pattern analyzer and corrector tool 735 into subclasses/subcategories that can be highlighted on a chip map, for example, or that can be sorted by cell type.

The pattern analyzer and corrector tool 735 also determines which allowed pattern of the pre-approved rule-in patterns has the closest similarity to the failed pattern at the marker location, by calculating a similarity index. Specifically, the pattern analyzer and corrector tool 735 calculates similarity indexes between each of the pre-approved structures and the failed pattern. In embodiments, the pattern analyzer and corrector tool 735 can calculate the similarity indexes by various methods, such as implementing the simple XOR function, the Jaccard XOR function, the weighted XOR function and feature vector, amongst other examples. The pattern analyzer and corrector tool 735 determines which of the pre-approved structures was the intended design for the failed pattern based on the highest similarity index score.

The pattern analyzer and corrector tool 735 corrects the failed pattern so that it matches the intended design, i.e., the pre-approved structure with the highest similarity score index. The correction of the failed pattern by the pattern analyzer and corrector tool 735 includes providing fixing guidance to morph the failed pattern to the pre-approved structure with the highest similarity index score. The correction of the failed pattern can be done fully automatically by the pattern analyzer and corrector tool 735, depending on the user's needs. In this way, the flagged patterns, i.e., the failed patterns 220, are corrected automatically. The pattern analyzer and corrector tool 735 can also perform the similarity check between the POI and the PAP patterns and corrections to the PAP described, e.g., in FIGS. 6A-6C.

The structures of the present disclosure can be manufactured in a number of ways using a number of different tools. In general, though, the methodologies and tools are used to form structures with dimensions in the micrometer and nanometer scale. The methodologies, i.e., technologies, employed to manufacture the structures of the present disclosure have been adopted from integrated circuit (IC) technology. For example, the structures are built on wafers and are realized in films of material patterned by photolithographic processes on the top of a wafer. In particular, the fabrication of the structure uses three basic building blocks: (i) deposition of thin films of material on a substrate, (ii) applying a patterned mask on top of the films by photolithographic imaging, and (iii) etching the films selectively to the mask.

The method(s) as described above is used in the fabrication of integrated circuit chips. The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed:

1. A method, comprising:
matching, by a computing device, patterns in a design layer to approved patterns;
determining, by the computing device, a similarity between at least one unmatched pattern and the approved patterns; and
correcting, by the computing device, the at least one unmatched pattern to match a pattern with the closest similarity out of the approved patterns.

2. The method of claim 1, wherein the design layer is a via layer, a front end of line layer or a back end of line layer.

3. The method of claim 1, wherein the determining the similarity comprises calculating a similarity score.

4. The method of claim 3, wherein the similarity score of 100% indicates identical patterns between the at least one unmatched pattern and the pattern with the closest similarity and a similarity score of 0% indicates no overlap between the at least one unmatched pattern and the pattern with the closest similarity.

5. The method of claim 3, further comprising setting, by the computing device, a threshold for the similarity score.

6. The method of claim 3, wherein the similarity score is calculated by an XOR function.

7. The method of claim 6, wherein the XOR function is a Jaccard XOR function which determines a structural difference between the at least one unmatched pattern and the approved patterns.

8. The method of claim 6, wherein the XOR function is a weighted XOR function which weighs structural differences between the at least one unmatched pattern and the approved patterns higher in a middle of the at least one unmatched pattern than other areas of the at least one unmatched pattern.

9. The method of claim 1, wherein the determining the similarity comprises calculating a similarity score by a feature vector.

10. The method of claim 9, wherein the feature vector is a weighted feature vector.

11. The method of claim 1, further comprising flagging the at least one unmatched pattern.

12. The method of claim 1, wherein the matched patterns are allowed patterns.

13. A computer program product comprising a computer readable storage medium having program instructions embodied therewith, and the program instructions are readable by a computing device to cause the computing device to:
find a match between patterns in a layout and patterns from a design library;
flag patterns which do not match the patterns from the design library;
calculate similarity scores between the flagged patterns and the patterns from the design library; and
correct the flagged patterns to match the patterns from the design library which have the closest similarity scores.

14. The computer program product of claim 13, wherein the similarity score is calculated by an XOR function by determining structural differences between the flagged patterns and the patterns from the design library.

15. The computer program product of claim 13, wherein the similarity score is calculated by a feature vector which compares a location and density of features in the patterns from the design library to a location and density of features in the flagged patterns.

16. The computer program product of claim 13, wherein the matched patterns are allowed patterns.

17. The computer program product of claim 13, wherein the flagged patterns are corrected automatically.

18. A system for rule checking, comprising:
a CPU, a computer readable memory and a computer readable storage media;
first program instructions to match patterns in a layer to approved patterns;
second program instructions to determine a similarity between at least one unmatched pattern and the approved patterns; and
third program instructions to correct the at least one unmatched pattern to match a pattern with the closest similarity out of the approved patterns,
wherein
the first, second and third program instructions are stored on the computer readable storage media for execution by the CPU via the computer readable memory.

19. The system of claim 18, wherein the determining the similarity comprises calculating a similarity score by image recognition algorithms.

20. The system of claim 18, wherein the layer is a via layer, a front end of line layer or a back end of line layer.
